(19) United States
(12) Patent Application Publication
(10) Pub. No.: US 2019/0021422 A1
(43) Pub. Date: Jan. 24, 2019

(54) Protective Clothing for Firefighters

(71) Applicants: Steve Burnett, Manhattan Beach, CA (US); Jeff Herdman, Manhattan Beach, CA (US)

(72) Inventors: Steve Burnett, Manhattan Beach, CA (US); Jeff Herdman, Manhattan Beach, CA (US)

(21) Appl. No.: 15/657,177

(22) Filed: Jul. 23, 2017

(51) Int. Cl. A41D 31/00; A62B 17/00

(52) U.S. Cl. CPC A41D 31/0027; A62B 17/003

(57) ABSTRACT

A shirt, as disclosed herein, includes a body component, comprising a front component, a back component, at least two side components, and at least two sleeve components, wherein the body component comprises a fire-resistant material.

### FIELD OF THE SUBJECT MATTER

The field of the subject matter is protective clothing for firefighters and workers who are exposed to high levels of heat and/or fire.

### BACKGROUND

Firefighters and other professionals who work with high degrees of heat and fire are continually concerned with their clothing—from the fit to the ability of the clothing to be layered to the ability of the clothing to be fire resistant alone or in combination with other clothing. In addition, these professionals are also concerned about the clothing's ability to effectively work to keep them as cool as possible in use.

For most firefighters, they wear an undershirt—possibly another shirt—and then the fire-resistant uniform or gear that covers their arms, legs, and torso. A typical undershirt may be one that wicks away sweat, but the shirt itself is not fire resistant. These types of shirts are usually made by companies like Under Armour and are similar to the shirts that athletes wear.

If the shirt is fire resistant, the fibers usually have been treated with a chemical that makes the overall garment fire resistant. In these instances, the chemical may weaken or wash out altogether after multiple uses and washes, which they need to be after almost every use. In other instances, the chemical may irritate the wearer's skin during use, making it—at best—uncomfortable to wear and at worst—impossible to wear every day.

Finally, the design of the shirt is a key consideration. An athlete, for example, needs a shirt that conforms to his or her body, thus not getting in the way of the athlete's activities. A firefighter, on the other hand, needs a shirt that won't bind or feel the wearer as though he or she is constrained. The shirt must also be able to accommodate a full range of the wearer's movements. In addition, the shirt must “give” in a way that allows it to adjust to the wearer's body when necessary. For example, a firefighter's torso or “core” may change significantly during a long day of fighting fires. From natural skin expansion caused by heat to torso expansion from fluid intake—the body changes. Any appropriate undershirt or shirt must be able to handle these rigorous demands.

To this end, it would be desirable to provide protective clothing for firefighters and other related workers that will: a) be fire resistant without chemical treatment, b) remain fire resistant after cleaning or washing, c) be designed to be worn under other layers of fire resistant clothing, d) wick moisture away from the body of the wearer, e) provide side-to-side comfort for the wearer, f) provide additional design features that aid these workers in wearing the clothing without traditional problems or issues with that clothing.

### SUMMARY OF THE SUBJECT MATTER

A shirt, as disclosed herein, includes a body component, comprising a front component, a back component, at least two side components, and at least two sleeve components, wherein the body component comprises a fire-resistant material.

### BRIEF DESCRIPTION OF THE FIGURES

FIG. 1 shows the front side of a contemplated shirt.

FIG. 2 shows the back side of a contemplated shirt.

FIG. 3 shows the side of a contemplated shirt.

### DETAILED DESCRIPTION

As desired, protective clothing has been developed for firefighters and other related workers that: a) is fire resistant without chemical treatment, b) remains fire resistant after cleaning or washing, c) is designed to be worn under other layers of fire resistant clothing, d) wicks moisture away from the body of the wearer, e) provides side-to-side comfort for the wearer, f) provides additional design features that aid these workers in wearing the clothing without traditional problems or issues with that clothing.

Specifically, a contemplated shirt, as disclosed herein, includes a body component, comprising a front component, a back component, at least two side components, and at least two sleeve components, wherein the body component comprises a fire-resistant material. In some embodiments, the body component consists entirely of a fire-resistant material. It should be understood that the fire resistant material is not chemically treated with a chemical that makes the material fire resistant. This concept will be described in detail herein.

Contemplated shirts, as disclosed herein, comprise a body component. As used herein, the phrase “body component” means that it is designed to be worn over and around the body. Contemplated body components may comprise any suitable fabric, as long as the fabric is fire resistant without any chemical coatings or application. It should be understood that there may be a fiber treatment process that dyes the fabric or keeps it from shrinking, but there are no fire-resistant chemicals applied to an otherwise non-fire-resistant shirt to make it fire resistant.

In some contemplated embodiments, contemplated fabrics comprise acrylic, rayon, nylon, or a combination thereof. In other embodiments, the rayon consists of cellulose fiber made from dissolving pulp (bleached wood pulp) using dry jet-wet spinning. In yet other embodiments, contemplated rayon is provided under the tradename LYOCELL, which will be referred to herein as “cellulosic rayon”. As contemplated herein, fabrics comprise at least 20% cellulosic rayon. In some embodiments, fabrics comprise at least 30% cellulosic rayon.

In some embodiments, contemplated fabrics comprise at least 40% acrylic fiber. In other embodiments, contemplated fabrics comprise at least 50% acrylic fiber. And in yet other embodiments, contemplated fabrics comprise about 55% acrylic fiber.

In some embodiments, contemplated fabrics comprise at least 5% nylon fiber. In other embodiments, contemplated fabrics comprise at least 10% nylon fiber. And in yet other embodiments, contemplated fabrics comprise at least about 15% nylon fiber.

In one contemplated embodiment, a contemplated shirt comprises a fabric having about 55% acrylic fiber, about 30% cellulosic rayon fiber, and about 15% nylon fiber. In yet another contemplated embodiment, a contemplated shirt comprises a fabric consisting of about 55% acrylic fiber, about 30% cellulosic rayon fiber, and about 15% nylon fiber. In another contemplated embodiment, a contemplated shirt comprises a fabric consisting essentially of about 55% acrylic fiber, about 30% cellulosic rayon fiber, and about 15% nylon fiber. In some embodiments, a contemplated fabric is referred to by the tradename TECHTT4, which is manufactured by TenCate.

It should also be noted that contemplated fabrics should meet certain levels of protection criteria. Contemplated fabrics must have less than about a 2 second response to a vertical flame test, which is the time it takes for a flame to be extinguished after being exposed to a vertical flame for 12 seconds. Contemplated fabrics must also have a char length of less than 6 inches×6 inches, which is the actual char length as measured after the vertical flame test. Contemplated fabrics should have an arc thermal protective value or ATPV of at least 4.8 CAL/CM2. Contemplated fabrics should be as light in weight as possible, in order to be as comfortable as possible when being worn by firefighters. They should also be able to stretch and should be able to recover and form back into shape easily.

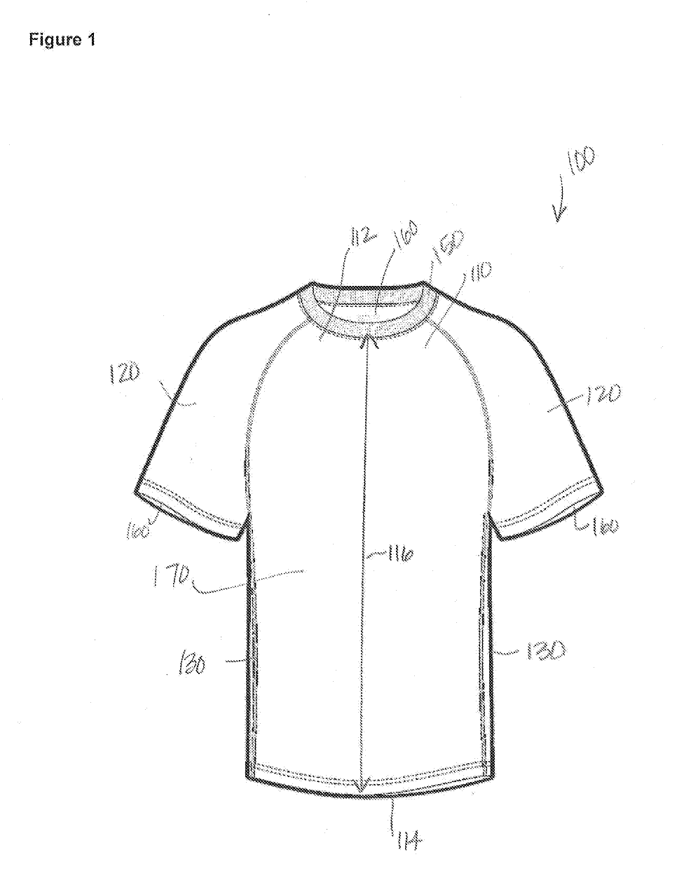

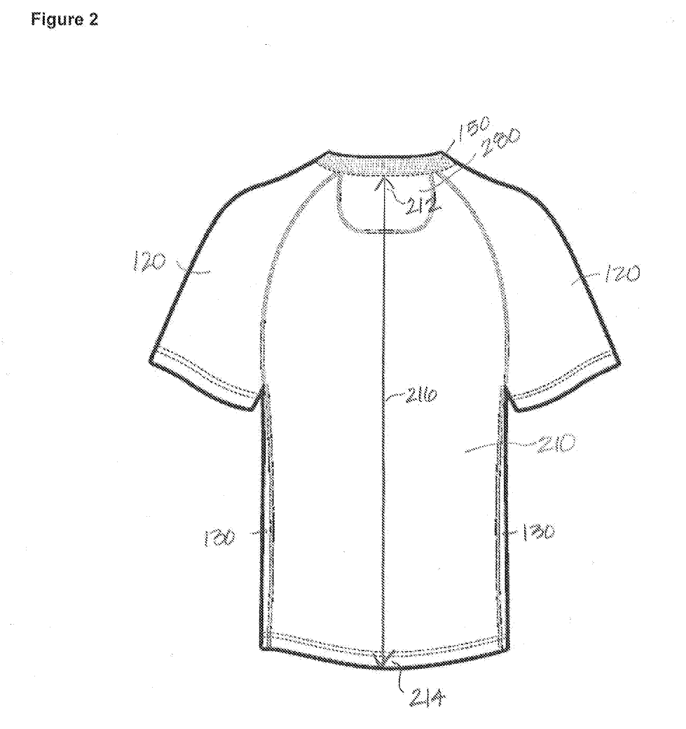

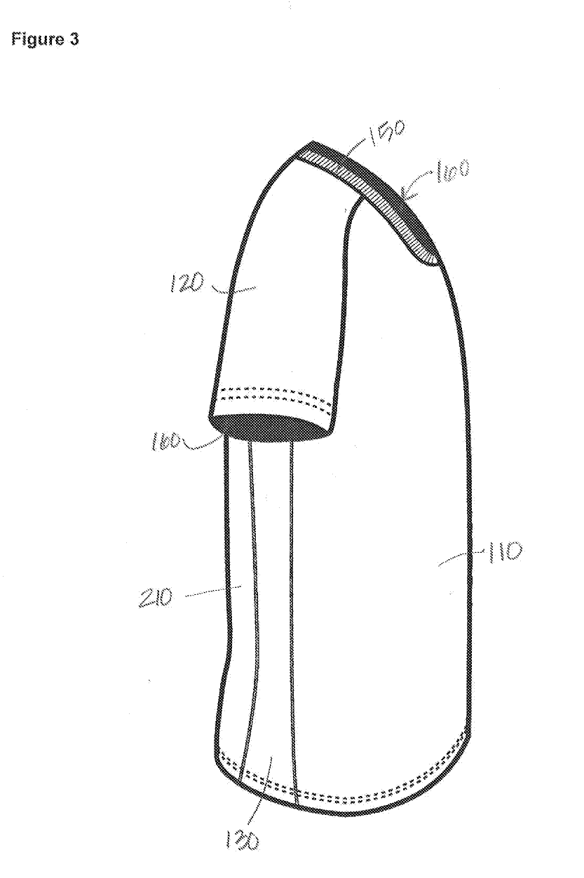

A contemplated body component 100 is shown in FIG. 1 and comprises an inside 160, an outside 170, a front component 110, a back component 210, at least two side components 130, and at least two sleeve components 120. Each of these components will be described herein. However, it should be understood that each of these components are connected to one another using a fire-resistant thread component, which may comprise a single-ply thread or a multi-ply thread. If the contemplated thread is a multi-ply thread, it is contemplated that each ply may contain or comprise the same material or may be made from materials different from the other ply or plies. The contemplated embodiments shown in FIGS. 1-3 are made from the materials disclosed herein.

In some embodiments, a contemplated body component 100 comprises a sewn-in neckline 150 that extends around the neck opening. In other embodiments, neckline 150 is made from the same material as the other components, but it is stitched in order to make it more durable than the rest of the body component. A contemplated stitching line is shown in FIG. 1.

Any suitable fire-resistant thread component would be contemplated. However, in some embodiments, a contemplated fire-resistant thread comprises a thread made from aramids. In other embodiments, a contemplated fire-resistant thread comprises a thread made from a meta variant of the aramids. In yet other embodiments, a contemplated fire-resistant thread comprises the tradename NOMEX, which will be referred to herein as an “aramid variant”.

A contemplated front component 110 is coupled with at least one sleeve component 120 and at least one side component 130. As used herein, the term “coupled” means that the front component, the at least one sleeve component, the at least one side component, or any combination thereof, may be transitionally-connected, in that one or more of them are not physically separated components, or may be physically connected, in that one or more of them are initially physically separated components that are stitched together. A contemplated front component comprises a directional distance line 116, from the top 112 of the front component, near the head of the wearer, to the bottom 114 of the front component, near the waist of the wearer.

A contemplated back component 210 is coupled with at least one sleeve component 120 and at least one side component 130. A contemplated back component 210 is designed to cover the back (not shown) of the wearer (not shown). A contemplated back component 210 comprises a directional distance line 216, from the top 212 of the back component, near the head of the wearer, to the bottom 214 of the back component, near the waist of the wearer. It is contemplated that the directional distance line 216 of the back component is at least 10% longer than the directional distance line 116 of the front component. In other embodiments, it is contemplated that the directional distance line of the back component is at least 25% longer than the directional distance line of the front component. In yet other embodiments, it is contemplated that the directional distance line of the back component is at least 40% longer than the directional distance line of the front component. It should be understood that this back component length is designed to fit better into the pants of the wearer, in order to provide better comfort and coverage during wearing.

In some embodiments, a contemplated back component comprises a shoulder component 280 that provides additional width to the shoulder area and may also strengthen the area around the neck.

A contemplated shirt also comprises at least two sleeve components. In contemplated embodiments, where at least one of the sleeve components is physically coupled to the front component and the back component, they are coupled using a raglan coupling technique. This technique is designed to run the seam down from the neck area of the shirt in an angle from the neck area down to near the armpit area of the shirt. In a raglan coupling technique, there are no seams on the top of the shirt running down the shoulder area or under the sleeve. This technique is important, because it provides additional comfort for firefighters when they are wearing additional layers on top of the contemplated shirt.

Contemplated shirts also comprise at least two side components, which are designed to provide maximum flexibility of movement for the wearer. In some embodiments, the side components are considered or function as gussets, in that they are sewn in or physically coupled with the other components, in order to strengthen it, enlarge it, or a combination thereof.

Thus, specific embodiments, methods of protective clothing for firefighters and other related professionals and workers have been disclosed. It should be apparent, however, to those skilled in the art that many more modifications besides those already described are possible without departing from the inventive concepts herein. The inventive subject matter, therefore, is not to be restricted except in the spirit of the disclosure herein. Moreover, in interpreting the specification and claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

We claim:

1. A shirt, comprising:
a body component, comprising a front component, a back component, at least two side components, and at least two sleeve components, wherein the body component comprises a fire-resistant material.

2. The shirt of claim 1, wherein the fire-resistant material comprises at least 20% of cellulosic rayon fiber.

3. The shirt of claim 1, wherein the fire-resistant material comprises at least 30% of cellulosic rayon fiber.

4. The shirt of claim 1, wherein the fire-resistant material comprises at least 50% acrylic fiber.

5. The shirt of claim 1, wherein the fire-resistant material comprises at least 15% nylon fiber.

6. The shirt of claim 1, wherein the fire-resistant material comprises 55% acrylic fiber, 30% cellulosic rayon fiber, and 15% nylon fiber.

7. The shirt of claim 1, wherein the fire-resistant material consists of 55% acrylic fiber, 30% cellulosic rayon fiber, and 15% nylon fiber.

8. The shirt of claim 1, wherein the front component, the back component, the at least two side components, and the at least two sleeve components are transitionally-coupled to one another.

9. The shirt of claim 1, wherein the front component, the back component, the at least two side components, and the at least two sleeve components are physically coupled to one another.

10. The shirt of claim 9, wherein the physically coupling is accomplished using a fire-resistant thread.

11. The shirt of claim 10, wherein the fire-resistant thread is single ply or multi-ply.

12. The shirt of claim 10, wherein the fire-resistant thread comprises an aramid variant material.

13. The shirt of claim 1, wherein the back component comprises a directional distance line, from the top of the back component to the bottom of the back component.

14. The shirt of claim 13, wherein the front component comprises a directional distance line, from the top of the front component to the bottom of the front component.

15. The shirt of claim 14, wherein the directional distance line of the back component is at least 10% longer than the directional distance line of the front component.

16. The shirt of claim 14, wherein the directional distance line of the back component is at least 25% longer than the directional distance line of the front component.

17. The shirt of claim 14, wherein the directional distance line of the back component is at least 40% longer than the directional distance line of the front component.
